(19) United States
(12) Patent Application Publication
(10) Pub. No.: US 2026/0111178 A1
(43) Pub. Date: Apr. 23, 2026

(54) LLM-Guided Software Dependency Discovery for Accelerated Development

(71) Applicant: Kuldeep Singh Chowhan, Leander, TX (US)

(72) Inventor: Kuldeep Singh Chowhan, Leander, TX (US)

(21) Appl. No.: 19/367,812

(22) Filed: Oct. 23, 2025

(51) Int. Cl. G06F 8/30; G06F 8/73; G06F 11/3668; G06F 16/3329

(52) U.S. Cl. CPC G06F 8/30; G06F 8/73; G06F 11/3684; G06F 16/33295

(57) ABSTRACT

Embodiments automate software discovery and delivery by decoupling repository understanding from change implementation. To aid the product- and technical-discovery phases of the SDLC, a large language model parses source code to produce human-readable technical documentation stored in a documentation store and machine-readable representations comprising vector embeddings linked in a graph store. When product requirements are received via a conversational user interface or a programmatic API, the system generates a change plan. An LLM identifies affected subsystems using graph and similarity queries, composes structured prompts, and conditions automated code transformation tools; communicated through a machine-to-machine orchestration layer (e.g., a Model Context Protocol (MCP) gateway); to generate candidate artifacts. Artifacts are validated by policy gates and packaged as a reviewable change record with documentation, embedding, and graph updates staged in a pre-deployment overlay; upon promotion, the system atomically commits the staged updates. Telemetry from review and deployment informs subsequent planning.

### CROSS REFERENCE TO RELATED APPLICATIONS

This application claims the benefit of U.S. Provisional Application No. 63/900,548, filed Oct. 16, 2025, the entirety of which is incorporated by reference herein.

### FIELD

The disclosure relates to automating a software discovery and delivery workflow using large language models (LLMs), vector and graph representations of codebases, and machine-to-machine orchestration of automated code editors.

### BACKGROUND

Software teams expend substantial effort in discovery-identifying where to implement changes safely across large codebases. Manual scoping, documentation, and coordination delay delivery and increase risk.

There is a need for systems that reduce discovery friction and accelerate delivery while preserving auditability, ownership controls, and quality gates.

### SUMMARY

Systems and methods automate software change delivery by decoupling repository understanding from change implementation. A large language model parses source code to produce (i) human-readable technical documentation stored in a documentation store and (ii) machine-readable representations comprising vector embeddings linked in a graph store. When product requirements are received via a conversational user interface or programmatic API, the system formalizes a change plan with tasks and acceptance criteria. Conditioned on retrievals from the documentation, vector, and graph stores, an LLM identifies affected subsystems and files and composes structured prompts for automated code transformation tools (optionally orchestrated through a protocol gateway). Candidate artifacts—code edits, tests, migrations, and documentation—are evaluated by policy gates and packaged as a reviewable change record. Documentation, embedding, and graph updates are staged in a pre-deployment overlay and atomically committed upon promotion. Telemetry from review and deployment informs subsequent planning.

### BRIEF DESCRIPTION OF THE DRAWINGS

FIG. 1 is a system overview for automating software discovery and delivery.

FIG. 2 is a flow diagram of repository parsing to produce human-readable documentation and vector embeddings with graph linkage.

FIG. 3 illustrates grounding and confidence scoring with retrieval from documentation, vector, and graph stores.

FIG. 4 shows retrieval and query planning using graph traversals and vector similarity with rank fusion for impact scoping.

FIG. 5 depicts policy-gate orchestration and decisioning: required vs. advisory gates, pass/fail aggregation, execution, and telemetry feedback.

FIG. 6 depicts artifact synthesis and packaging as a reviewable change record with a staging overlay and commit upon promotion.

FIG. 7 depicts requirements intake via a conversational user interface and a programmatic API, request schema validation, and generation of a change plan.

FIG. 8 depicts orchestration via a Model Context Protocol (MCP) gateway: structured prompts routed to automated code editors, sandboxed edits returned as candidate patches with provenance.

### DETAILED DESCRIPTION

Reference numerals include 182 (vector index), 184 (graph store), 186 (documentation store), 500 (change plan), 600 (synthesis), 610 (bundler), 630 (conversational UI), 640 (requirements API), 650 (validator), 660 (plan generator), 670 (MCP gateway), 680 (automated editors), 690 (patch return channel), 190 (reviewable change record), 170 (telemetry).

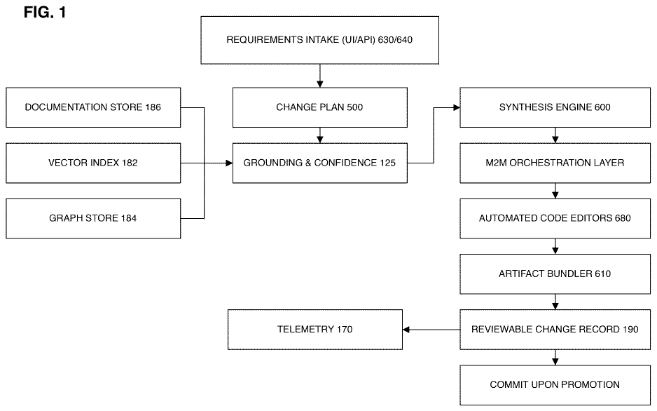

In FIG. 1, documentation store 186, vector index 182, and graph store 184 prime the system by capturing code structure and semantics before any change is planned. Requirements arrive via UI 630 or API 640 and are translated into a change plan 500, conditioned by grounding 125 and synthesis 600.

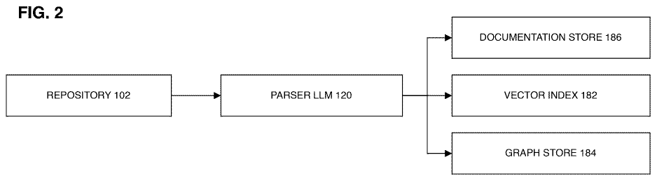

In FIG. 2, repository 102 is parsed by LLM 120 to emit human-readable documentation into store 186 and vector embeddings into index 182, which are linked to graph nodes and edges in store 184.

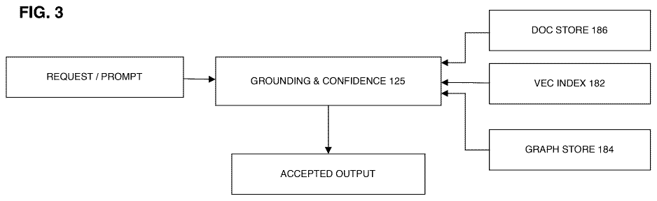

In FIG. 3, retrieved passages from 186, top-k neighbors from 182, and graph neighborhoods from 184 condition outputs; confidence thresholds gate acceptance, and low-confidence generations may be rejected or rewritten.

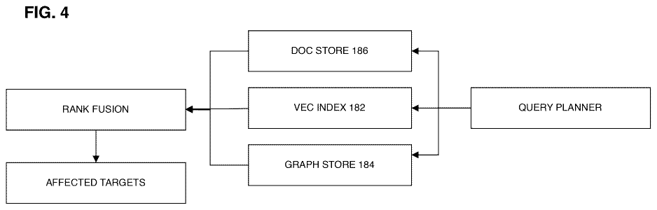

In FIG. 4, graph traversals (CALLS, IMPORTS, OWNS, DATA-FLOWS) and vector similarity are fused to rank impacted subsystems and files for targeted modification.

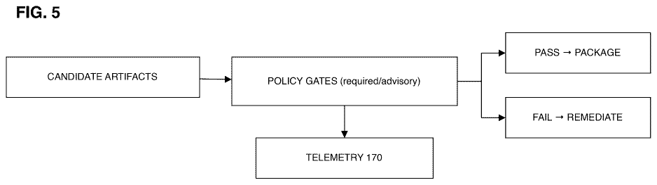

In FIG. 5, required and advisory gates (static analysis, license, secrets, performance, ownership) return structured findings that drive pass, remediation, or advisory outputs; telemetry 170 loops signals back to planning.

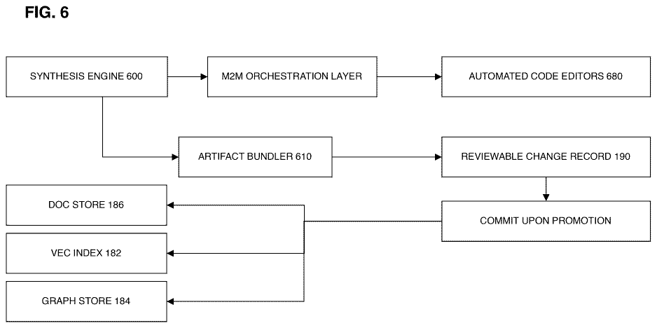

In FIG. 6, structured prompts drive synthesis 600; artifacts are bundled 610 into a reviewable change record 190. Documentation, embeddings, and graph updates are staged in a pre-deployment overlay and committed upon promotion to maintain referential integrity across stores 186/182/184.

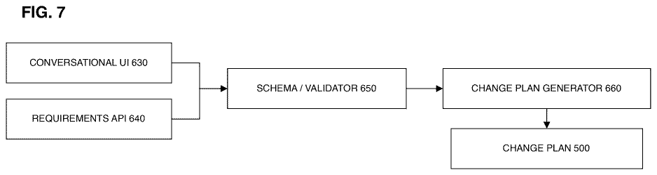

In FIG. 7, the conversational UI 630 and requirements API 640 accept feature requests validated against a schema 650 and formalized into a change plan 500 by the plan generator 660.

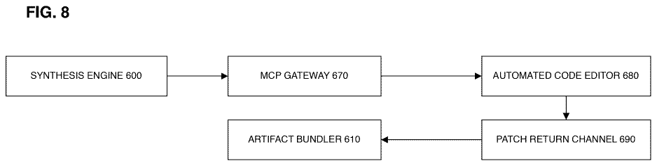

In FIG. 8, an orchestration layer, such as an MCP gateway 670, routes structured prompts to automated code editors 680; patches and provenance return via channel 690 and are packaged by bundler 610.

### EXAMPLES (NON-LIMITING)

The following examples are incorporated from the Examples and Prompt Pack. Numbering is for convenience and does not limit scope.

### Example 1: Master Parsing Prompt (System)

Use this as the system/developer prompt for repo parsing tasks. Outputs must be JSON-only and map to stores 186/182/184.

### System

You are an expert software developer and code archaeologist. Your job is to read source files like an engineer would-trace imports and calls, spot API endpoints, follow data I/O, and note config/infrastructure details-then produce two things:
1) Human-readable documentation chunks for the Documentation Store (186).
2) Machine-readable records for the Vector Index (182) and Graph Store (184).

### Strict Output Rules:

Return ONLY JSON matching the task's schema. No prose, no chain-of-thought, no extra keys.
Cite file paths and exact line (or byte) spans for anything you claim.
Use stable identifiers (e.g., deterministic chunk_id). Do not invent facts; leave unknowns null/empty.

### How to “Read” Like an Engineer:

Dependencies: record IMPORTS/CALLS edges; include I/O (READS/WRITES), external services, queues/topics, SQL tables, feature flags, and env usage.
APIs: detect HTTP/GRPC/CLI/events; extract verbs/routes/status codes; link route→handler symbol.
Symbols: capture functions/classes/methods with signatures and line anchors.
Tests: point to likely test files; note gaps (e.g., no e2e, missing negative cases).
Infra/Config: build tools, runtimes, CI, policies (lint/typecheck/license/security). Never output secrets—only note their presence/paths.
Ownership (heuristic): map directories or CODEOWNERS to teams/emails when evidence is strong (≥0.7 confidence).

### General Policies:

Respect file boundaries and spans-summarize only what's shown.
Keep summary_md concise and developer-useful; keep embedding_text self-contained (no code blocks).
Normalize paths (POSIX) and language names (“python”, “typescript”, “dockerfile”).
If uncertain, omit or set null-don't guess.

### Goal Alignment:

summary_md→Documentation Store 186
embedding_text→Vector Index 182
graph_edges (+symbols/APIs/deps)→Graph Store 184

### Output Format:

Always return the task's JSON with chunks: [ . . . ] of DocChunk records, exactly as specified by the task schema.

### Example 2: Requirements API Intake and Change Plan Generation

A product-management service submits a structured request to the Requirements API (640). The Request Schema/Validator (650) normalizes and validates the payload. The Change Plan Generator (660) emits a Change Plan (500) with tasks, acceptance criteria, and gate requirements.

```
POST /api/v1/requirements
Content-Type: application/json
{
  “request_id”: “REQ-2025-00123”,
  “feature_intent”: “Enable bulk user deactivation from the admin
portal”,
  “acceptance_criteria”: [
    “Given a CSV of user IDs, when submitted by an admin with role
‘ORG_OWNER’, then the system disables associated sessions
within 60s”,
    “Affected users see ‘Account disabled’ on next login attempt”,
    “Audit log written with actor, timestamp, and count”
  ],
  “user_journeys”: [“admin_portal.manage_users.bulk_actions”],
  “priority”: “P1”,
  “constraints”: {
    “performance_budget_ms”: 200,
    “data_classification”: “internal”,
    “ownership”: [“teams/identity”, “teams/audit”]
  },
  “auth”: { “actor”: “pm@example.com”, “roles”: [“PM”] }
}
```

### Illustrative Response (Truncated):

```
HTTP/1.1 202 Accepted
Content-Type: application/json
{
  “change_plan_id”: “CP-2025-00456”,
  “tasks”: [
    {
      “id”: “T-1”,
      “title”: “Add bulk deactivation API”,
      “acceptance”: [“unit:test_bulk_deactivate”,
“e2e:admin_bulk_disable”],
      “owners”: [“teams/identity”],
      “gates”: [“sast”, “ownership”, “perf”]
    },
    {
      “id”: “T-2”,
      “title”: “Write audit trail”,
      “acceptance”: [“unit:audit_record”, “e2e:audit_bulk_disable”],
      “owners”: [“teams/audit”],
      “gates”: [“license”, “secrets”]
    }
  ],
  “trace”: {
    “docs”: “retrieved: 12 passages from documentation store 186”,
    “graph_nodes”: 38,
    “vector_topk”: 20
  }
}
```

### Example 3: MCP Message to Automated Code Editor (Refactor+Test Generation)

The Synthesis Engine (600) composes a structured prompt using citations from the Documentation Store (186), a graph neighborhood from the Graph Store (184), and top-k neighbors from the Vector Index (182). The prompt is dispatched to an automated code editor (680) via the MCP gateway (670).

```
{
  “protocol”: “mcp-compliant”,
  “tool”: “code_editor.apply_patch”,
  “tool_instance”: “editor-680B”,
  “call_id”: “CALL-9df2b”,
  “arguments”: {
    “repo”: “ssh://git.example.com/monorepo.git”,
    “branch”: “feature/REQ-2025-00123”,
    “target_files”: [“services/identity/bulk_deactivate.py”,
“services/identity/api.py”],
    “context”: {
      “docs_snippets”: [
        {“id”: “doc-186-42”, “title”: “Identity Service API”,
“excerpt”: “...bulk actions policy...”}
      ],
      “graph_neighborhood”: {
        “center”: “Symbol:IdentityService#deactivateUsers”,
        “depth”: 2,
        “edges”: [“calls”,“imports”,“ownership”]
      },
      “vector_topk”: [
        {“file”: “services/identity/session.py”, “score”: 0.84}
      ],
      “acceptance_criteria”: [
        “Disable active sessions within 60s”,
        “Write audit log entry”
      ]
    },
    “instructions”: “Add endpoint POST /admin/bulk-deactivate;
implement CSV handling; enforce ‘ORG_OWNER’ role; call
deactivateUsers( ); write audit log; include unit tests.”
  }
}
```

Editor response (JSON with unified diff and provenance):

```
{
  “call_id”: “CALL-9df2b”,
  “status”: “ok”,
  “artifacts”: [
    {
      “type”: “patch”,
      “file”: “services/identity/api.py”,
      “diff”: “--- a/services/identity/api.py\n+++
b/services/identity/api.py\n@@...”,
      “provenance”: {
        “editor”: “editor-680B”,
        “model”: “code-model”,
        “inputs”: [“doc-186-42”,
“graph:IdentityService#deactivateUsers”,
“vec:services/identity/session.py”]
      }
    },
    {
      “type”: “test”,
      “file”: “services/identity/tests/test_bulk_deactivate.py”,
      “content”: “import pytest\n...”
    }
  ],
  “metrics”: {“latency_ms”: 9320, “tokens”: 18472}
}
```

### Example 4: Commit Upon Promotion

Upon promotion (e.g., merge or deploy), the Commit Service atomically applies staged deltas to the Documentation Store (186), Vector Index (182), and Graph Store (184).

```
POST /api/v1/promotion
Content-Type: application/json
{
  “change_record_id”: “RCR-7890”,
  “action”: “merge”,
  “branch”: “main”
}
Example 5: Common JSON Schema for Repo Parsing
{
  “chunks”: [
    {
      “chunk_id”: “string”,
      “repo”: “string”,
      “commit”: “string”,
      “file_path”: “string”,
      “language”: “string”,
      “span”: {“start_line”: 10, “end_line”: 140},
      “summary_md”: “string”,
      “keywords”: [“string”, “...”],
      “symbols”: [
        {“name”: “string”, “kind”: “class|function|method|type|const”,
“signature”: “string”, “visibility”: “public|internal|private”, “line”:
42}
      ],
      “apis”: [
        {“type”: “http|grpc|cli|event”, “method”: “GET|POST...”,
“route”: “/v1/users”, “status_codes”:[200,400,500]}
      ],
      “deps”: [
        {“type”:
“imports|calls|reads|writes|sql_table|topic|queue|env|feature_flag”,
          “source”: “Symbol#name”, “target”:
          “Symbol#name|pkg|table”,
“detail”: “string”}
      ],
      “owners”: [“teams/identity”, “owners@example.com”],
      “risks”: [“uses deprecated API X”, “potential PII write”],
      “tests”: {“has_tests”: true, “paths”: [“tests/test_users.py”],
“gaps”: [“no e2e”]},
      “citations”: [{“file_path”:“...”, “start_line”: 10, “end_line”:
24}],
      “embedding_text”: “string”,
      “graph_edges”: [
        {“src”:“file:services/api/users.py”, “edge”:“IMPORTS”,
“dst”:“pkg:fastapi”},
        {“src”:“sym:UserService#create”, “edge”:“CALLS”,
“dst”:“sym:DB#insert_user”}
      ]
    }
  ]
}
```

### Example 6: Task Prompt T1-T9

### T1—Repository Overview (Roots, Build, Services)

DEVELOPER
Task: Produce a repository overview from the provided file manifest and top-level files.
Input:
   repo: {{repo_id}}
   commit: {{commit_sha}}
   files: {{file_list_json}}
   root_readmes: {{readme_snippets}}
   build_files: {{build_snippets}}
   service_layout: {{tree_snippet}}
Requirements:
   Identify primary languages, build systems, service boundaries, subsystems.
   Emit 1-5 DocChunk records (summary_md+embedding_text+minimal graph_edges).
Return JSON per schema.

### T2—File/Module Summarization (Chunked)

DEVELOPER
Task: Summarize a file segment and extract symbols.
Input:
   repo: {{repo_id}}, commit: {{commit_sha}}
   file_path: {{path}}, language: {{lang}}
   content: |
{{code_segment}}
   span: {“start_line”: {{start}}, “end_line”: {{end}}}
Requirements:
   Crisp summary_md; extract symbols/signatures; embedding_text concise; citations with span.
Return JSON per schema (1 DocChunk).

### T3—API Surface Extraction (HTTP/GRPC/CLI/Events)

DEVELOPER
Task: Extract API endpoints and link to handlers.
Input:
   repo: {{repo_id}}, commit: {{commit_sha}}
   file_path: {{path}}, language: {{lang}}
   content: |
{{code_segment}}
Rules:
   Detect HTTP verbs/routes/params/status; link route→handler (edge HANDLES); summarize auth.
Return JSON per schema (1 DocChunk).

### T4—Dependency Edges (Imports, Calls, I/O)

DEVELOPER
Task: Extract dependency edges from this code segment.
Input:
   repo: {{repo_id}}, commit: {{commit_sha}}
   file_path: {{path}}, language: {{lang}}
   content: |
{{code_segment}}
Edges to emit: IMPORTS, CALLS, READS, WRITES, SQL_TABLE, QUEUE/TOPIC, ENV, FEATURE_FLAG.
Return JSON per schema (1 DocChunk) with precise ‘detail’ strings.

### T5—Test Coverage & Gaps

DEVELOPER
Task: Infer tests and identify gaps.
Input:
   repo: {{repo_id}}, commit: {{commit_sha}}
   file_path: {{path}}
   code: |
{{code_segment}}
   test index: {{test_paths_json}}
Output: tests.has_tests, tests.paths, tests.gaps. Keep summary_md tight.
Return JSON per schema (1 DocChunk).

### T6—Infra/Config (Build, IaC, Secrets, Policies)

DEVELOPER
Task: Parse infra/config to document build & runtime constraints.
Input:
   repo: {{repo_id}}, commit: {{commit_sha}}
   file_path: {{path}}
   content: |
{{config_text}}
Capture: runtimes/tools, CI, policies, sensitive-config references (no secrets). Emit CONFIG_OF edges when clear.
Return JSON per schema (1 DocChunk).

### T7—Data Model & Migrations

DEVELOPER
Task: Extract data entities and migrations.
Input:
   file_path: {{path}}
   content: |
{{schema_or_migration}}
Extract: tables/collections, keys/indexes, migration direction, side-effects. Emit SQL_TABLE/MIGRATES edges.
Return JSON per schema.

### T8—Ownership Heuristics (Optional)

DEVELOPER
Task: Attribute ownership hints.
Input:
   file_path: {{path}}
   codeowners: {{codeowners text}}
   blame_sample: {{git_blame_json}}
   dirs_to_team_map: {{map_json}}
Rules: owners[ ] best-effort; emit OWNS edge when confidence≥0.7; else omit.
Return JSON per schema.

### T9—Embedding-First Synthesis (Text Only)

DEVELOPER
Task: Produce a standalone narrative for embeddings.
Input:
   file_path: {{path}}
   prior_summary: {{summary_md}}
   key_symbols: {{symbol_list_json}}
   key_deps: {{deps_list_json}}
Rules: 4-8 sentences, task-oriented, no code fences, self-contained.
Return JSON with: chunk_id, file_path, embedding_text.

### Example 7: Tiny Concrete Example (T2)

Input excerpt:
file_path: services/identity/api.py
language: python
span: 40-115
content:
@router.post(“/admin/bulk-deactivate”)
def bulk deactivate(csv: UploadFile, actor: User=Depends(get actor)):

assert actor.role == “ORG_OWNER”
ids = parse_csv(csv)
for id in ids:
deactivate_sessions(id) # writes to redis
audit.log(actor=actor.email, count=len(ids))
return {“status”:“ok”}

Expected JSON (truncated):

```
{
  “chunks”: [{
    “chunk_id”: “doc-186-identity-api-40-115”,
    “repo”: “git.example/monorepo”,
    “file_path”: “services/identity/api.py”,
    “language”: “python”,
    “span”: {“start_line”: 40, “end_line”: 115},
    “summary_md”: “POST /admin/bulk-deactivate accepts a CSV of user
IDs. Only ORG_OWNER actors may invoke it. For each ID, sessions are
deactivated and an audit record is written. Returns JSON status.”,
    “symbols”:
[{“name”:“bulk_deactivate”,“kind”:“function”,“signature”:“bulk_deactiva
te(csv, actor)”,“visibility”:“public”,“line”:40}],
    “apis”: [{“type”:“http”,“method”:“POST”,“route”:“/admin/bulk-
deactivate”,“status_codes”:[200,400,403,500]}],
    “deps”: [
{“type”:“calls”,“source”:“sym:bulk_deactivate”,“target”:“sym:parse_csv”
,“detail”:“parse input”},
{“type”:“calls”,“source”:“sym:bulk_deactivate”,“target”:“sym:deactivate
_sessions”,“detail”:“writes to redis”},
{“type”:“writes”,“source”:“sym:bulk_deactivate”,“target”:“topic:audit_l
og”,“detail”:“audit.log(...)”},
{“type”:“env”,“source”:“sym:bulk_deactivate”,“target”:“role:ORG_OWNER”,
“detail”:“authorization requirement”}
    ],
    “tests”: {“has_tests”: false, “paths”: [ ], “gaps”:[“no e2e”,“no
negative-role test”]},
    “citations”:
[{“file_path”:“services/identity/api.py”,“start_line”:40,“end_line”:115
}],
    “embedding_text”: “Admin-only endpoint to bulk deactivate user
sessions from a CSV. Validates ORG_OWNER role, parses input,
deactivates sessions, and writes audit entries. Returns simple JSON
status.”,
    “graph_edges”: [
      {“src”:“route:/admin/bulk-
deactivate”,“edge”:“HANDLES”,“dst”:“sym:bulk_deactivate”},
{“src”:“sym:bulk_deactivate”,“edge”:“CALLS”,“dst”:“sym:deactivate_sessi
ons”}
    ]
  }]
}
```

What is claimed is:

1. A computer-implemented method for automating software discovery and delivery, the method comprising: (a) ingesting repository content from a version-control system; (b) parsing, by a large language model (LLM), the repository content to produce (i) human-readable technical documentation stored in a documentation store and (ii) machine-readable representations comprising vector embeddings in a vector index and links in a graph store that models subsystems, files, and relationships; (c) receiving, via at least one of a conversational user interface and a programmatic application programming interface (API), a request that expresses product requirements for a change; (d) generating, from the request, a change plan that specifies tasks and acceptance criteria; (e) identifying, by the LLM conditioned on retrievals from the documentation store, the vector index, and the graph store, candidate subsystems and files whose modification satisfies the product requirements; (f) synthesizing structured prompts that condition automated code transformation tools to implement the change plan; (g) obtaining, from the automated tools, candidate artifacts comprising at least a source-code modification and optionally one or more of tests, documentation updates, data migrations, or design records; (h) executing one or more policy gates against the candidate artifacts; (i) responsive to passing the policy gates, packaging the candidate artifacts as a change record for a development workflow and staging associated documentation, embedding, and graph updates in a pre-deployment overlay associated with the change record; (j) upon promotion of the change record, atomically committing the staged updates to the documentation store, the vector index, and the graph store; and (k) recording telemetry from at least one of review, integration, deployment, and rollback events to inform subsequent change planning.

2. The method of claim 1, wherein step (c) further comprises maintaining conversational session context that includes prior requirements, clarifications, or approvals and binding the session context to the change plan.

3. The method of claim 1, wherein step (e) further comprises generating, by the LLM, rank-fusion scores that combine graph proximity in the graph store with cosine similarity in the vector index to prioritize targets.

4. The method of claim 1, wherein step (b) further comprises segmenting files into boundary-aware chunks and emitting cross-references that link documentation chunks, embeddings, and graph nodes via stable identifiers.

5. The method of claim 1, wherein the policy gates of step (h) return structured findings that distinguish required violations from advisory findings, and wherein failures trigger automated remediation instructions incorporated into the structured prompts of step (f).

6. The method of claim 1, wherein step (f) or step (g) further comprises using a machine-to-machine orchestration layer including a gateway that implements a Model Context Protocol (MCP) for tool discovery, authentication, rate-limiting, and routing.

7. The method of claim 1, wherein the automated tools return, with the candidate artifacts, provenance that identifies tools, models, inputs, and references to retrieved passages from the documentation store, the vector index, and the graph store.

8. The method of claim 1, wherein the pre-deployment overlay of step (i) is scoped to a branch or change identifier corresponding to the change record, and provides preview and rollback isolation prior to the committing of step (j).

9. The method of claim 1, wherein step (e) comprises extracting ownership constraints from the graph store to avoid proposing changes to files not owned by teams identified in the change plan.

10. The method of claim 1, wherein recording telemetry in step (k) comprises updating models that prioritize future tasks and adjust acceptance criteria based on observed review and deployment outcomes.

11. The method of claim 1, wherein the graph store comprises typed edges including at least one of CALLS, IMPORTS, READS, WRITES, OWNS, PUBLISHES, CONSUMES, or MIGRATES.

12. The method of claim 1, wherein step (g) further comprises generating one or more of unit tests, end-to-end tests, or performance tests that correspond to the acceptance criteria of the change plan.

13. The method of claim 1, wherein step (b) produces documentation in a human-readable markup that references symbol names, API routes, data flows, and policy requirements, and wherein the documentation is indexed for retrieval by symbol, file, and subsystem.

14. The method of claim 1, wherein step (j) comprises an atomic transaction that concurrently updates the documentation store, the vector index, and the graph store to maintain referential integrity across the stores.

15. The method of claim 1, wherein the programmatic API of step (c) accepts a schema-validated request that includes feature intent, acceptance criteria, user journeys, priority, and constraints comprising at least one of performance budget, data classification, or team ownership.

16. A system comprising one or more processors and memory storing instructions that, when executed by the one or more processors, cause the system to perform operations comprising the steps of the method of claim 1.

17. A non-transitory computer-readable storage medium storing instructions that, when executed by one or more processors, cause performance of the steps of the method of claim 1.
